(19) United States
(12) Patent Application Publication
(10) Pub. No.: US 2016/0095016 A1
(43) Pub. Date: Mar. 31, 2016

(54) REQUESTING EXTRA SPECTRUM

(71) Applicants: MOHAMED EL-REFAEY, Cairo (EG); NORHAN M. OSMAN, Giza (EG); HAZEM ABDELMEGEED, Maadi (EG); HANI ELGEBALY, Cairo (EG)

(72) Inventors: MOHAMED EL-REFAEY, Cairo (EG); NORHAN M. OSMAN, Giza (EG); HAZEM ABDELMEGEED, Maadi (EG); HANI ELGEBALY, Cairo (EG)

(21) Appl. No.: 14/499,033

(22) Filed: Sep. 26, 2014

(51) Int. Cl. H04W 28/18; H04W 72/04

(52) U.S. Cl. CPC H04W 28/18; H04W 72/0453; H04W 4/24

(57) ABSTRACT

A device for use in a mobile communication user equipment includes processing circuitry to prepare a spectrum allocation request for requesting extra spectrum according to a predetermined protocol; send the spectrum allocation request to a cloud spectrum broker; and receive a response to the spectrum allocation from the cloud spectrum broker. A device for use in a cloud spectrum broker, the device comprising processing circuitry to receive from a user equipment an allocation request, the allocation request for requesting extra spectrum, the allocation request according to a predetermined protocol; determine a response to the allocation request; and send the response to the user equipment.

### TECHNICAL FIELD

Embodiments relate generally to wireless communications and more particularly to systems and methods for dynamically allocating spectrum for mobile broadband applications.

### BACKGROUND

The world is heading to a global spectrum shortage triggered by the wireless data explosion. New digital and wireless technologies, including cell phones, satellites, and high-definition television, are dramatically changing how people use the airwaves. Since the early days of radio and telegraph transmission, the available radio spectrum in the United States and other jurisdictions has been carved up by regulatory agencies into discrete bands or channels. Use of spectrum bands has been restricted to certain types of users or certain licensees. Availability of wireless spectrum for the plethora of mobile devices is key to the continued use of the spectrum to exchange data or content. Exclusive mobile broadband licenses are near exhaustion and the discussion in the industry has already moved from spectrum sale to spectrum rental. There is a worldwide push for regulations that allow licensed spectrum holders to rent their un-used or under-utilized spectrum to other entities with a desire to use the spectrum. This creates a win-win situation where, for example mobile operators get access to spectrum they otherwise would not have, while the spectrum holders with un-used spectrum get some form of compensation. This is particularly attractive to the licensed spectrum holders (non-cellular) who may be underutilizing their spectrum but cannot relinquish the spectrum (say by selling it in the secondary market) since they have use for it in certain areas or at certain times.

Some of the suggested industry solutions use spectrum sensing by the client to detect un-used spectrum and to allocate it using utility models based on fairness, content type, and differences in the provider. These suggested solutions would create fragmentation and lead to inefficiencies that would only exacerbate the current problems. The primary spectrum holders who rent their spectrum out usually have two main requirements: Firstly, they need to be able to regain control of their spectrum when they need it and there needs to be a clear mechanism for this. Secondly, they like to be in control of what portion of their spectrum gets rented. The spectrum sensing solution does not meet these requirements since the client device that detects available spectrum would not be under the control of the primary spectrum holder. Other suggested solutions include using a cognitive pilot channel (wireless spectrum) to advertise available un-used spectrum, which, in turn, uses more spectrum. Use of static databases to locate unused spectrum is also common when information does not change for at least 24 hours.

### BRIEF DESCRIPTION OF THE DRAWINGS

FIG. 1 illustrates a system suitable for use with some embodiments.

FIG. 2 shows different perspectives taken into consideration in some embodiments.

FIG. 3 illustrates a set up phase in accordance with some embodiments.

FIG. 4 illustrates a spectrum allocation process in accordance with some embodiments.

FIG. 5 shows a spectrum reclaim process in accordance with some embodiments.

FIG. 6 illustrates a method according to some examples.

FIG. 7 illustrates a method according to some examples.

FIG. 8 illustrates an example system according to some embodiments.

FIG. 9 shows an embodiment of a user equipment.

### DESCRIPTION OF EMBODIMENTS

Various embodiments of the disclosure are discussed in detail below. While specific implementations are discussed, it should be understood that this is done for illustration purposes only. A person skilled in the relevant art will recognize that other components and configurations may be used.

Although embodiments are not limited in this regard, discussions utilizing terms such as, for example, “processing,” “computing,” “calculating,” “determining,” “applying,” “receiving,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of devices” may include two or more devices.

The term “spectrum asset” is a right to use, usually in a specific geographic area, a range of electromagnetic radiation, from the highest frequency to the lowest. The spectrum encompasses everything from X-rays and gamma rays to visible light and radio waves. Additionally, the spectrum asset can be reduced to a set of time slots selected from a group consisting of hours, days, time blocks, minutes, seconds, or smaller units of time, or to a frequency range that is also reducible to a set of time slots.

The term “Cloud Spectrum Services (CSS)” is used herein to refer to a dynamic spectrum allocation scheme that uses a cloud-based database and optimization engine to allocate available spectrum to client devices.

The term “Multi-mode device (MMD)” is used herein to primarily refer to a wireless device to transmit and/or receive data to/from a fixed network infrastructure, and includes for example a mobile device, tablet, computing device, TV sets, hand held (HH) device. An MMD could also be capable of directly using spectrum resources assigned by a Cloud Spectrum Broker CSB. An MMD can engage in wired or wireless communication with other devices.

The term “Primary Spectrum Holder (PSH)”, in the context of a cloud spectrum services (CSS) transaction, is a spectrum owner with rights conveyed by a regulatory authority to a portion of the radio spectrum that will be dynamically managed by a CSB and reallocated for temporary use to MMDs and/or Alternate Spectrum Holders (ASHs). Examples include TV broadcasters, cellular operators, and government agencies (military, public safety, and the like). However, in some cases the PSH may be an alternate spectrum holder (described below) or an MMD that currently owns Time Frequency Units (TFUs) for that spectrum and behaves as a PSH when attempting to re-trade its assigned TFUs to another alternate spectrum holder or MMD.

The term “Alternate Spectrum Holder (ASH)” as used herein is any entity that provides MMDs with access to a fixed network infrastructure. Examples include cellular operators and government agencies. In Cloud Spectrum Services (CSS) an ASH is a user that can request spectrum from a Cloud Spectrum Broker. In some embodiments, an ASH may negotiate spectrum resources with a Cloud Spectrum Broker for the purpose of allocation to its associated MMDs. This simplifies the implementation complexity of the associated MMDs by allowing all negotiations to take place between the ASH and the Cloud Spectrum Broker.

The term Global Broker (GB) is used to refer to an entity responsible for the spectrum auctioning procedure.

The term “Cloud Spectrum Database (CSD)” is used herein to refer to a device to store data that are used by a global broker to dynamically manage a spectrum asset such as a radio spectrum resource, i.e., spectrum availability at a given time in a given location. The CSD can be deployed by a third party or as part of an ASH or PSH network. The CSD may contain current and/or future information about available spectrum at any given location and time. The CSD may also contain other information. The information contained in the CSD may be determined based on regulatory policies, and may include information on one or more of geo-location, date, time, bandwidth, coverage and information about a specific band of spectrum, such as an owner of the spectrum, spectrum occupancy, availability, etc.

The term “Content Provider (CP)” is used herein to refer to content providers such as ESPN, Netflix, Hulu, Disney and Amazon. A CP may establish service agreements directly with MMDs and use the services of a CSB to ensure reliable delivery of content to MMDs across any communication infrastructure such as wireless media. In Cloud Spectrum Services (CSS) a CP is a user that can request spectrum from a Cloud Spectrum Broker.

The term “Cloud Spectrum Broker (CSB)” refers to the entity responsible for managing CSS transactions (e.g. transactions transferring TFUs from a PSH to an ASH or MMD, or reclaiming TFUs from an ASH or MMD back to the corresponding PSH) and for optimizing the use of the spectrum asset like a radio spectrum resource across a geographical area on the basis of parameters such as PSH offerings, ASH requirements and requests, MMD capabilities and requests, CP offerings and requirements, and application requirements. A CSB may initiate queries to PSHs based on requests received directly from MMDs or ASHs.

The term “controller” is used herein generally to describe various apparatus relating to the operation of one or more device that direct or regulate a process or machine. A controller can be implemented in numerous ways (e.g., such as with dedicated hardware) to perform various functions discussed herein. A “processor” is one example of a controller that employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

The term “wireless device” as used herein includes, for example, a device capable of wireless communication, a communication device capable of wireless communication, a communication station capable of wireless communication, a portable or non-portable device capable of wireless communication, or the like. In some embodiments, a wireless device may be or may include a peripheral device that is integrated with a computer, or a peripheral device that is attached to a computer.

Disclosed embodiments include an architecture that allows ASH's such as mobile operators or users to access spectrum they would otherwise not be permitted or allowed to access. For example, this may allow the end user to complete a download during congested periods while maintaining high service quality. Embodiments may allow the holder of spectrum (PSH) to be compensated for an otherwise idle asset. Thus, embodiments benefit all parties, while also offloading computational burdens from each party. The process is a computationally intensive optimization problem rather than a communication problem, and is well-suited to the cloud server environment.

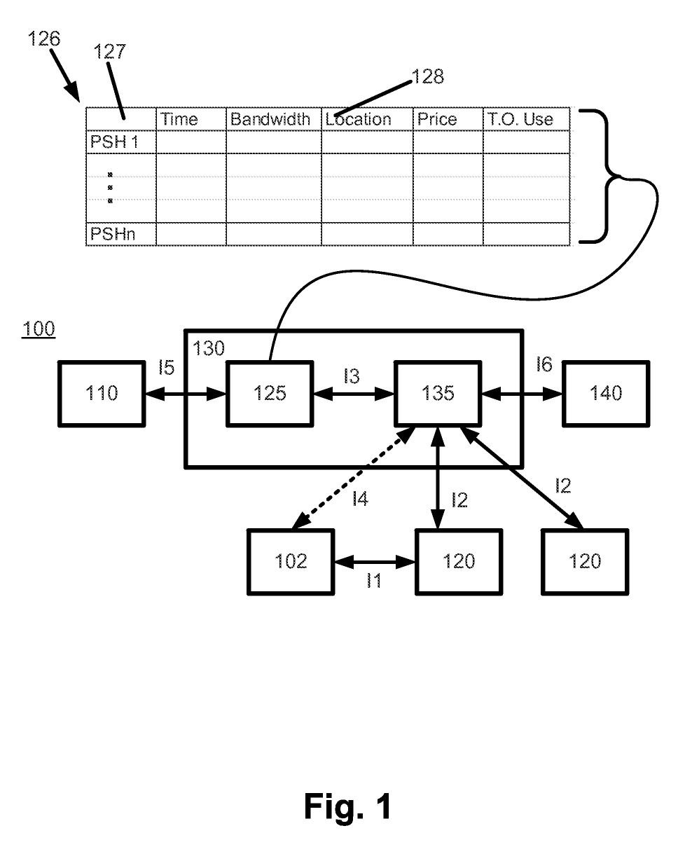

FIG. 1 illustrates the overall architecture of a cloud spectrum service system 100 in accordance with an embodiment. Spectrum service system 100 comprises primary spectrum holder (PSH) 110, alternate spectrum holder(s) 120 (ASH), a global broker 135, a cloud spectrum database 125, content provider 140, Multi-mode device 102 having connectivity to a communication network (not shown), each of these features may or may not have direct connectivity to one another, according to various embodiments and system architectures.

By way of example, the communication network includes one or more networks such as a wired data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), WiGig, wireless LAN (WLAN), Bluetooth®, Internet Protocol (IP) data casting, satellite, mobile ad-hoc network (MANET), and the like, or any combination thereof.

The system of FIG. 1 provides a framework for dynamic spectrum allocation. In this embodiment, it is proposed to use the cloud or cloud computing to manage and optimize the complex transactions associated with dynamic spectrum sharing. The centralized access of the cloud enables better operational effectiveness as all client devices such as MMDs will be cloud connected, and able to cease using (or relinquish) the shared spectrum when the spectrum holder signals its need for access. Spectrum management and load balancing are computationally intensive problems, and the complex transactions can be performed more effectively in the centralized computationally intensive environment of the cloud.

CSS is a dynamic spectrum allocation scheme that uses cloud-based database 125 and optimization engine to allocate available spectrum to client devices such as MMD 102. The CSS database 125 receives dynamic spectrum availability information from the PSH identifying the primary holder and spectrum asset descriptors. The spectrum asset descriptors may include one or more of time, bandwidth, terms of use, price, and location, taken jointly, severally or in any and all permutations. The availability information may be formatted to any suitable database structure and may be stored by a memory. A tabular form of the spectrum availability information is shown as table 126. The table 126 lists the primary spectrum holder 127 and spectrum asset descriptors 128. In addition to collecting and organizing spectrum information, database 125 may maintain spectrum rules, or an inference engine, to manage rules for spectrum use, including rules established by the primary spectrum holder 110, government regulations, or rules agreed upon by the parties. A key part of the CSS concept is that user devices will likely continue to use their operator's primary spectrum to maintain ongoing connectivity; in such cases CSS allocation spectrum will be incremental increases in bandwidth for the client devices or for base stations, access points and the like. It is important to note that because the availability and the need for spectrum is communicated to a cloud based spectrum management system it may be possible to accomplish and maintain optimal (or a high or near-optimal level of) spectrum utilization. Advertising the spectrum for allocation will insure that all or a majority of the bandwidth will be carrying communication traffic.

Global broker 135 is an auctioneer functional entity, the entity responsible for the spectrum auctioning procedure between local brokers. The global broker 135 may apportion the spectrum using classification algorithms such as binary tree bin packing algorithm.

Local brokers are bidder functional entities, and may correspond with the network operators. The local broker exchanges messages between the global broker and subscribers (MMDs). The local broker is responsible for receiving a spectrum allocation from the global broker to satisfy demands from users.

Apportionment of unallocated spectrum may include, for example, removing from the database unallocated or newly available spectrum into segments and arrangement of the segments to fulfill a spectrum request without overlapping with existing spectrum usage. The apportionment algorithm may be designed to identify an optimal configuration of spectrum segments such as time-frequency units within specified constraints. Based on the frequency and time coordinates provided by the primary spectrum holder, the algorithm may create a finite number of “segments” (e.g., unallocated spectrum blocks) and “fill” (e.g., allocate) these bins with “objects” (e.g., complete or partial spectrum requests) so that the number of segments used is maximized or minimized depending on an objective. Using the apportioning algorithm, newly available spectrum, for example, may be efficiently allocated to a number of simultaneous requests for the spectrum.

In the CSS process the cloud spectrum broker 135 acquires information about a spectrum asset from the primary spectrum holder 110 in order to offer the spectrum asset to users of spectrum, such as content provider 140, client devices such as MMD 102, or alternate spectrum holder 120. Spectrum may be made available from PSH 110 in the form of a spectrum commodity item that may, in turn, form a spectrum offer that may be defined in terms of one or more of time, bandwidth, location, price, and term of use of the spectrum. The PSH 110 may make multiple offers and for multiple time durations. In turn, the broker may make these spectrum allocations available to interested parties through push marketing or pull marketing of the advertised spectrum. The broker may provide information back to the license holder about the utilization of the spectrum in the form of one or more acceptance messages. There may be more than one acceptance message for a given spectrum commodity item or associated offer requesting more or less spectrum and possible negotiations as to quality of service or other descriptors that relate to the spectrum.

The interfaces between the elements of the system 100 are labeled as 11-16 in FIG. 1.

Database 125 provides for integrating a geographical area such as a region or state and current availability of spectrum asset into a single unit. This single unit may then be used to facilitate and to expedite identification of one or more of spectrum, price, bandwidth, and other attributes and, further, to execute the matching of spectrum available for allocation to a request for spectrum from a user. Note that database 125 of CSS 100 could also be used to identify holders of certain spectrums and to have the cloud spectrum broker query the identified holder to specific spectrum on behalf of a user

As an example of a hypothetical CSS-based dynamic spectrum allocation scenario, say a communication Provider Company A has a customer with a MMD such as MMD 102, and that customer wishes to download a video from a content provider that may or may not be affiliated with Company A during peak hours, but Communication Provider's (e.g., Company A) bandwidth threshold at that particular time and cell site would be exceeded. Communication Provider's (e.g., Company A) systems would be programmed to automatically detect this on behalf of the client device such as MMD 102, and request temporary spectrum from the CSS cloud by communicating with the Cloud Spectrum Broker 135. CSS would then analyze the request and fill the order from its inventory of spectrum for allocation (e.g. spectrum offered as available for allocation by a Primary Spectrum Holder (PSH), say an astronomy agency, which only uses its network from 3-4 AM local time).

CSS would then send Communication Provider's (e.g., Company A) system the temporary spectrum assignment details making the Communication Provider (e.g., Company A) the Alternate Spectrum Holder (ASH) 120. Next, Communication Provider's (e.g., Company A) system sends out programming instructions for the appropriate base station and the client device such as MMD 102 to add this incremental band to its useable spectrum. Then, the user's download of the video proceeds, without the user being aware of these details. This entire process would be completed in a fraction of a second, similar, in principle, to machine-to-machine HFT (high frequency trading) transactions in securities markets (which also perform computationally intensive optimization operations as part of a sub-second multi-party transaction). It should be understood that the functions of the global broker 135 and cloud spectrum database 125 can be integrated into a single system such as a broker database 130. Qualified participants may search the comprehensive broker database 130 to identify the availability of spectrum and facilities such as antenna towers and the like. This permits any two entities to enter into a direct communication when a match between the parties exists regarding availability, infrastructure, and length of desired use.

The request for spectrum could also originate from the content provider 140 who wants to ensure their customers receive a certain level or quality of service. The global broker can receive a request directly from the client such as MMD 102, assuming such operation complies with the terms of use, from the operator or from the content provider 140. It uses the information in the database to perform complex optimizations to maximize spectrum utilization. Availability of spectrum, together with its terms of use conditions, are advertised to the Cloud Spectrum Broker by PSHs 110 and updated. In some embodiments, the updating may be performed periodically.

All devices including primary spectrum holder, alternate spectrum holder, broker database, Multi-mode device, may comprise a form of controller or computer having a processor, a memory, and an operating system, capable of interaction with a user or other devices, and shall include without limitation desktop computers, notebook computers, personal digital assistants (PDAs), smartphone, servers, handheld computers, and similar devices. These devices may include one or more displays.

The CSS system 100 uses elements such as the global broker 135 and the cloud spectrum database 125. These elements must communicate with each other and other more traditional elements of the system. According to some embodiments, such communication may be facilitated by provisioning a protocol for CSS communication and signaling between two or more elements of system 100. This protocol may be referred to as cloud spectrum services (CSS) Signaling and Messaging Protocol (CSMP). CSMP may enable or improve integration of CSS with a traditional network (or other network). In some embodiments, CSMP defines, controls and manages the messaging communications and transactions that occur in the context of Cloud Spectrum and Brokerage Services.

The CSMP protocol may be an asynchronous messaging system, and may be an independent set of APIs that supports a set of features that support the allocation and release of spectrum and allows clients' devices to place orders and requests to obtain extra spectrum to accumulate on their primary spectrum to increase the capacity.

Embodiments provide generic, configurable and extensible protocol messages to be transmitted between different entities in the CSS architecture, providing each entity with sufficient information to function efficiently and reliably.

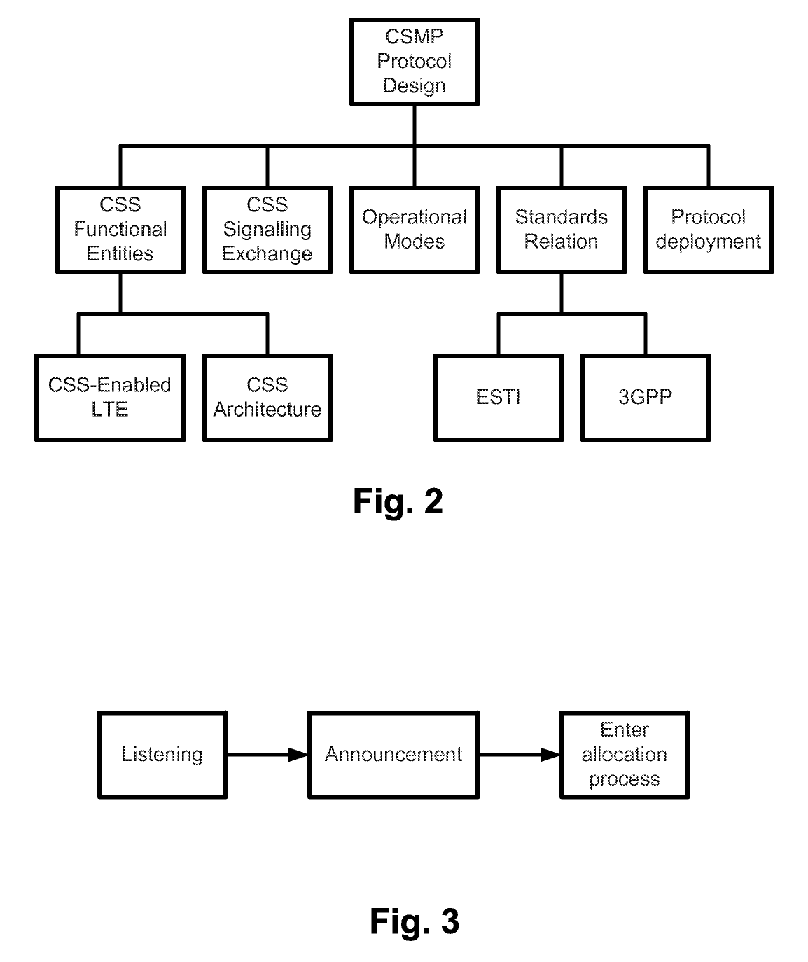

FIG. 2 is a hierarchical diagram showing the different perspectives that were taken into consideration in designing the protocols according to some embodiments. According to some embodiments, the protocols permit the elements of the CSS system to interact with each other easily and with a well-defined set of rules.

According to some embodiments, CSMP provides:
Listening for incoming spectrum allocation requests.
Announcement of radio spectrum availability.
Spectrum allocation requests initiation.
Cloud spectrum database authentication and authorization.
Cloud spectrum database register/unregister requests.
Cloud spectrum database updates of allocated spectrum message.
Spectrum availability Response.
Place a spectrum allocation request to PSH.
Reclaiming allocated spectrum to original spectrum owner (e.g. PSH or operators).
Establishing connections between brokers.
Channel availability request/response.
Provide a unified interface for the dynamic selection of radio access technology and spectrum bands.

### Protocol Lifecycle and Operational Modes

According to some embodiments, the lifecycle of the messaging exchange includes three processes:
Set up phase.
Spectrum allocation process.
Spectrum reclaim process.

### Set Up Phase

Before an allocation process begins, the global broker 135 is in a listening and announcement state. The global broker 135 waits for requests from local brokers 120. If the global broker 135 has available spectrum for allocation and no requests have been received, it may enter an announcement state. In the announcement state, the global broker may send a broadcast message to all local brokers providing the details of the available spectrum. This phase is illustrated in FIG. 3.

Spectrum Allocation Process

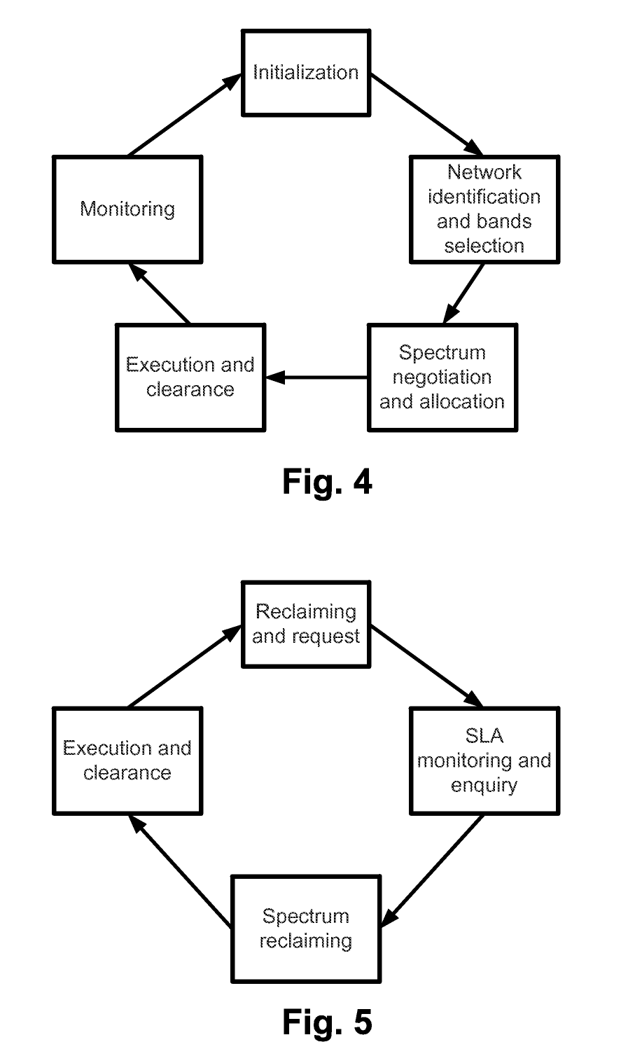

FIG. 4 illustrates the spectrum allocation process, which includes:
Phase 1: Initialization, authentication. Here the ASH has the option to send or not send information on its requirements for spectrum (needs information).
Phase 2: Network identification and bands selection.
Phase 3: Spectrum negotiation and allocation.
Phase 4: Execution and clearance.
Phase 5: Monitoring.

### Spectrum Reclaim Process

The spectrum reclaim process is illustrated in FIG. 5, and includes the following phases:
Phase 1: Request for reclaiming spectrum.
Phase 2: SLA monitoring and enquiry.
Phase 3: Spectrum recalling.
Phase 4: Execution and clearance.

### Interface Specifications

The interface I1 between MMD and CSB is used to exchange the following information:

| MMD->CSB | CSB->MMD |
|---|---|
| Allocation request for extra spectrum | Acknowledgement |
| Mobility model | List of available networks |
| Radio interface | Spectrum window |
| Authorization | |
| Put price | |

Interface I2 is used to exchange signals between the global broker and the CSB. Signals may be transmitted from the global broker to the CSB or from the CSB to the global broker.

Interface I3 is used to exchange signals between the global broker and the CSD. Signals may be transmitted from the global broker to the CSD or from the CSD to the global broker.

Interface I4 is used to exchange signals between the MMD and the global broker. Signals may be transmitted from the MMD to the global broker or from the global broker to the MMD.

Interface I5 is used to exchange signals between the PSH and the CSD. The interface may exchange the following information:

| PSH->CSD | CSD->PSH |
|---|---|
| Spectrum ready to be allocated | Acknowledgement |
| Time window and schedule | |
| Radio and MMD context info | |
| Authorization | |

Interface I6 is used to exchange signals between the content provider and the global broker. Signals may be transmitted from the content provider to the global broker or from the global broker to the content provider.

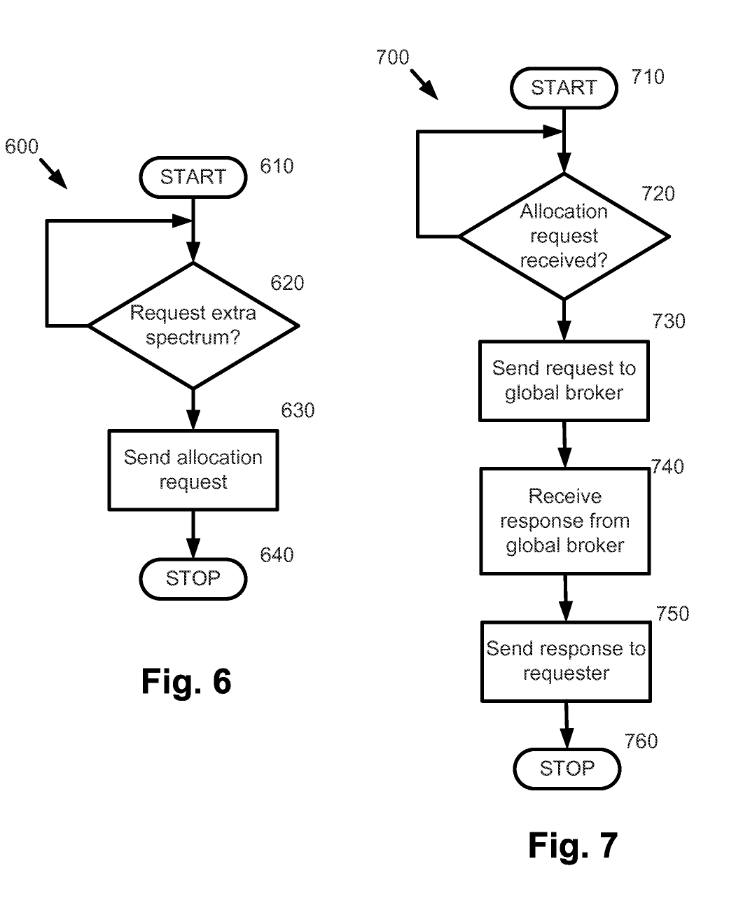

FIG. 6 illustrates a method 600 of requesting extra spectrum according to some examples. In some examples, the method may be implemented by a user equipment of a MMD. The method begins at 610 and at 620 a determination is made regarding whether or not extra spectrum should be requested. When it is determined that extra spectrum should not be requested the method continues to loop back to 620 until it is determined that extra spectrum should be requested. This determination may be based on a criterion or metric such as, for example, a comparison between required and available quality of service, for example. The determination may be performed automatically or may be made based on input from a user.

When it is determined at 620 that extra spectrum should be requested, the method proceeds to 630, where an allocation request is sent to a cloud spectrum broker; the request being according to a protocol. The method terminates at 640.

FIG. 7 illustrates a method 700 according to some examples. In some examples the method may be implemented by a Cloud Spectrum Broker. The method begins at 710, and at 720 the device implementing the method listens for an allocation request for extra spectrum (e.g. from a user equipment, MMD, etc.) where the request is according to a protocol. The method continues to loop back to 720 until a request is received. If a request is received, the method proceeds to 730. At 730 a request is sent to the global broker for extra spectrum. The request is sent according to a protocol. At 740 a response is received from the global broker, the response being sent according to a protocol. At 750 the device implementing the method sends a response to the requesting entity (e.g. the UE or MMD), the response to the requesting entity is based on the response from the global broker, and is sent according to a protocol. The method terminates at 760.

It should be noted that the allocation of bandwidth by the global broker may be based on an auction system taking into consideration monetary or other compensation offered for the allocation of the bandwidth. However, other considerations may also be taken into account, such as, for example, the most efficient usage of the available bandwidth. In some examples, the allocation of extra bandwidth may be independent of any monetary or compensation considerations. The spectrum process allocation may be or may include a spectrum rental process, and the allocation of spectrum may be a rental of spectrum.

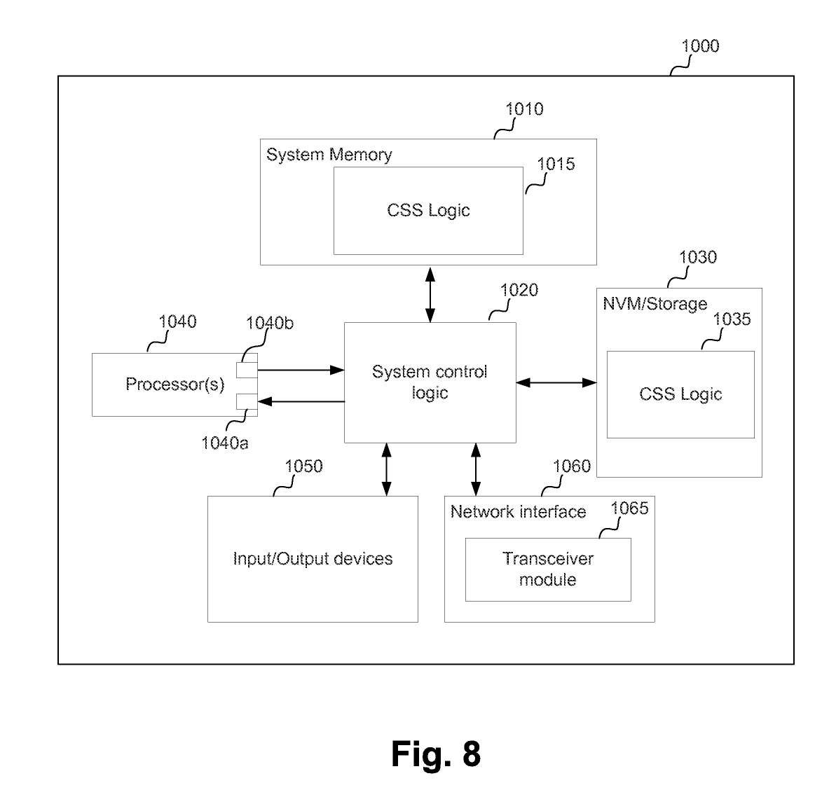

The Cloud Spectrum Broker 120 and UE 102 described herein may be implemented using any suitable hardware and/or software. FIG. 8 illustrates an example system 1000 according to some embodiments. System 1000 includes one or more processor(s) 1040, system control logic 1020 coupled with at least one of the processor(s) 1040, system memory 1010 coupled with system control logic 1020, non-volatile memory (NVM)/storage 1030 coupled with system control logic 1020, and a network interface 1060 coupled with system control logic 1020. The system control logic 1020 may also be coupled to Input/Output devices 1050.

Processor(s) 1040 may include one or more single-core or multi-core processors. Processor(s) 1040 may include any combination of general-purpose processors and dedicated processors (e.g., graphics processors, application processors, baseband processors, etc.). Processors 1040 may be operable to carry out the above described methods, using suitable instructions or programs (i.e. operate via use of processor, or other logic, instructions). The instructions may be stored in system memory 1010, as system memory portion (CSS logic) 1015, or additionally or alternatively may be stored in (NVM)/storage 1030, as NVM instruction portion (CSS logic) 1035.

CSS logic 1015 and/or 1035 may include a logic to cause a processor 1040 to perform CSS functions, such as requesting extra spectrum or responding to such requests.

Processors(s) 1040 may be configured to execute the embodiments of FIGS. 6 and 7 in accordance with various embodiments.

System control logic 1020 for one embodiment may include any suitable interface controllers to provide for any suitable interface to at least one of the processor(s) 1040 and/or to any suitable device or component in communication with system control logic 1020.

System control logic 1020 for one embodiment may include one or more memory controller(s) to provide an interface to system memory 1010. System memory 1010 may be used to load and store data and/or instructions, for example, for system 1000. System memory 1010 for one embodiment may include any suitable volatile memory, such as suitable dynamic random access memory (DRAM), for example.

NVM/storage 1030 may include one or more tangible, non-transitory computer-readable media used to store data and/or instructions, for example. NVM/storage 1030 may include any suitable non-volatile memory, such as flash memory, for example, and/or may include any suitable non-volatile storage device(s), such as one or more hard disk drive(s) (HDD(s)), one or more compact disk (CD) drive(s), and/or one or more digital versatile disk (DVD) drive(s), for example.

The NVM/storage 1030 may include a storage resource physically part of a device on which the system 1000 is installed or it may be accessible by, but not necessarily a part of, the device. For example, the NVM/storage 1030 may be accessed over a network via the network interface 1060.

System memory 1010 and NVM/storage 1030 may respectively include, in particular, temporal and persistent copies of, for example, the CSS logic 1015 and 1035, respectively. CSS logic 1015 and 1035 may include instructions that when executed by at least one of the processor(s) 1040 result in the system 1000 implementing a one or more of methods 600 and/or 700, or the method(s) of any other embodiment, as described herein. In some embodiments, instructions 1015 and 1035, or hardware, firmware, and/or software components thereof, may additionally/alternatively be located in the system control logic 1020, the network interface 1060, and/or the processor(s) 1040.

Network interface 1060 may have a transceiver module 1065 to provide a radio interface for system 1000 to communicate over one or more network(s) (e.g. wireless communication network) and/or with any other suitable device. The transceiver 1065 may perform the various communicating, transmitting and receiving described in the various embodiments, and may include a transmitter section and a receiver section. In various embodiments, the transceiver 1065 may be integrated with other components of system 1000. For example, the transceiver 1065 may include a processor of the processor(s) 1040, memory of the system memory 1010, and NVM/Storage of NVM/Storage 1030. Network interface 1060 may include any suitable hardware and/or firmware. Network interface 1060 may be operatively coupled to a plurality of antennas to provide a multiple input, multiple output radio interface. Network interface 1060 for one embodiment may include, for example, a network adapter, a wireless network adapter, a telephone modem, and/or a wireless modem. For example, where system 1000 is a cloud spectrum broker, network interface 1060 may include an Ethernet interface, an S1-MME interface and/or an S1-U interface.

For one embodiment, at least one of the processor(s) 1040 may be packaged together with logic for one or more controller(s) of system control logic 1020. For one embodiment, at least one of the processor(s) 1040 may be packaged together with logic for one or more controllers of system control logic 1020 to form a System in Package (SiP). For one embodiment, at least one of the processor(s) 1040 may be integrated on the same die with logic for one or more controller(s) of system control logic 1020. For one embodiment, at least one of the processor(s) 1040 may be integrated on the same die with logic for one or more controller(s) of system control logic 1020 to form a System on Chip (SoC). Each of the processors 1040 may include an input 1040a for receiving data and an output 1040b for outputting data.

In various embodiments, the I/O devices 1050 may include user interfaces designed to enable user interaction with the system 1000, peripheral component interfaces designed to enable peripheral component interaction with the system 1000, and/or sensors designed to determine environmental conditions and/or location information related to the system 1000.

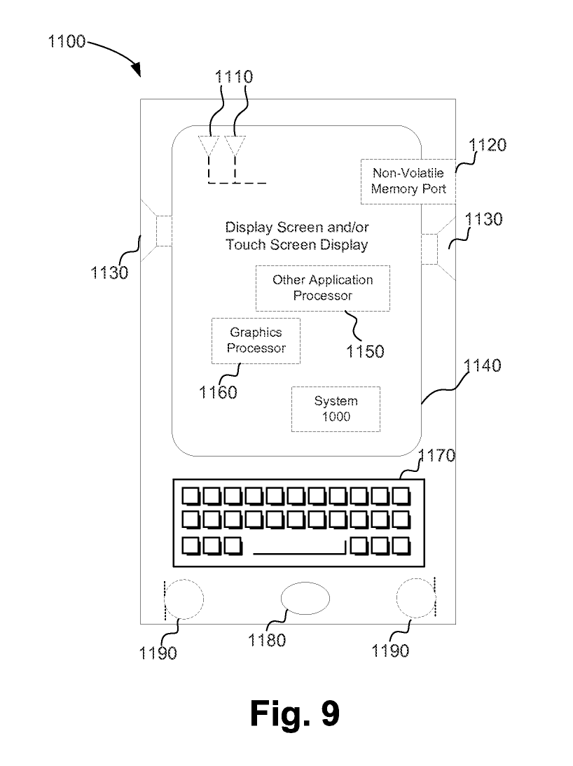

FIG. 9 shows an embodiment in which the system 1000 implements a UE 102 in the specific form of a mobile device 1100.

In various embodiments, the user interfaces could include, but are not limited to, a display 1140 (e.g., a liquid crystal display, a touch screen display, etc.), a speaker 1130, a microphone 1190, one or more cameras 1180 (e.g., a still camera and/or a video camera), a flashlight (e.g., a light emitting diode flash), and a keyboard 1170.

In various embodiments, the peripheral component interfaces may include, but are not limited to, a non-volatile memory port, an audio jack, and a power supply interface.

In various embodiments, the sensors may include, but are not limited to, a gyro sensor, an accelerometer, a proximity sensor, an ambient light sensor, and a positioning unit. The positioning unit may also be part of, or interact with, the network interface 1060 to communicate with components of a positioning network, e.g., a global positioning system (GPS) satellite.

In various embodiments, the system 1100 may be a mobile computing device such as, but not limited to, a laptop computing device, a tablet computing device, a netbook, a mobile phone, etc. In various embodiments, system 1100 may have more or less components, and/or different architectures.

As used herein, “processing circuitry to/configured to/arranged to” perform a function comprises at least one of “hardware configured to”, “software configured to” and a “combination of hardware and software configured to” perform that function.

In embodiments, the implemented wireless network may be a 3rd Generation Partnership Project's long term evolution (LTE) advanced wireless communication standard, which may include, but is not limited to releases 8, 9, 10, 11 and 12, or later, of the 3GPP's LTE-A standards.

Where operations are described as multiple discrete operations, this is for the purpose of explaining the illustrative embodiments; however, the order of description should not be construed as to imply that these operations are necessarily order dependent. In particular, these operations need not be performed in the order of presentation.

The terms “comprising,” “having,” and “including” are synonymous, unless the context dictates otherwise. The phrase “NB” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

Unless contrary to physical possibility, the inventors envision the methods described herein: (i) may be performed in any sequence and/or in any combination; and (ii) the components of respective embodiments may be combined in any manner.

Although there have been described example embodiments of this novel invention, many variations and modifications are possible without departing from the scope of the invention. Accordingly the inventive embodiments are not limited by the specific disclosure above, but rather only by the scope of the appended claims and their legal equivalents.

Embodiments within the scope of the present disclosure may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that performs particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Various processes to support the establishment of an automated spectrum trading and the optimization of spectrum allocation have been described. Using the disclosed approach, efficient and productive use of spectrum may be made, while minimizing the procedural and transactional burdens on spectrum holders or spectrum users. Although the above description may contain specific details, they should not be construed as limiting the claims in any way. Other configurations of the described embodiments of the disclosure are part of the scope of this disclosure. For example, the principles of the disclosure may be applied to each individual user where each user may individually deploy such a system. This enables each user to utilize the benefits of the disclosure even if any one of the large number of possible applications do not need the functionality described herein. In other words, there may be multiple instances of the components each processing the content in various possible ways. It does not necessarily need to be one system used by all end users.

Various embodiments can be realized according to the following clauses:

1. A device for use in a mobile communication user equipment, UE, the device comprising processing circuitry to:

prepare a spectrum allocation request for requesting extra spectrum according to a predetermined protocol;

send the spectrum allocation request to a cloud spectrum broker; and

receive a response to the spectrum allocation from the cloud spectrum broker.

2. The device of clause 1, wherein the processing circuitry is to send further information to the cloud spectrum broker, the further information including at least one of:

an indication of a mobility model for the requested extra spectrum,

an indication of a radio interface for the requested extra spectrum,

authorization information associated with the spectrum allocation request,

a put price.

3. The device of clause 2, wherein the processing circuitry is to prepare the further information according to the predetermined protocol before sending the further information to the cloud spectrum broker.

4. The device of any preceding clause, wherein the processing circuitry is further to receive an acknowledgement from the cloud spectrum broker in response to the spectrum allocation request.

5. The device of any preceding clause, wherein the processing circuitry is further to receive, from the cloud spectrum broker, a list of available networks for providing the requested extra spectrum.

6. The device of any preceding clause, wherein the processing circuitry is further to receive, from the cloud spectrum broker, an indication of a spectrum window for providing the requested extra spectrum.

7. A user equipment comprising:

the device of any preceding clause; and

one or more of: a screen, a speaker, a touchscreen, a keyboard, an antenna array including a plurality of antennas, a graphics processor, an application processor.

8. A method of requesting extra spectrum, the method comprising:

determining that extra spectrum should be requested;

determining information to be sent in an allocation request, the allocation request for requesting allocation extra spectrum; and

sending the allocation request to a cloud spectrum broker, the allocation request being sent according to a predetermined protocol.

9. The method of clause 8, wherein the method further comprises sending to the cloud spectrum broker at least one of:

an indication of a mobility model for the requested extra spectrum,

an indication of a radio interface for the requested extra spectrum,

authorization information associated with the allocation request,

a put price.

10. The method of clause 8 or clause 9, wherein the processing circuitry is further to receive from the cloud spectrum broker at least one of:

an acknowledgement in response to the allocation request,

a list of available networks for providing the requested extra spectrum,

an indication of a spectrum window for providing the requested extra spectrum.

11. A device for use in a cloud spectrum broker, the device comprising processing circuitry to:

receive from a user equipment an allocation request, the allocation request for requesting extra spectrum, the allocation request according to a predetermined protocol;

determine a response to the allocation request; and

send the response to the user equipment.

12. The device of clause 11, wherein the response to the user equipment is according to the predetermined protocol.

13. The device of clause 11 or clause 12, wherein the allocation request includes at least one of:

an indication of a mobility model for the requested extra spectrum,

an indication of a radio interface for the requested extra spectrum,

authorization information associated with the allocation request,

a put price.

14. The device of any one of clauses 11 to 13, wherein the processing circuitry is to

send a request for spectrum to a global broker;

receive a response to request for spectrum from the global broker; and

determine the response to the allocation request based on the response to the request for spectrum.

15. The device of any one of clauses 11 to 14, wherein the response to the user equipment includes at least one of:

an acknowledgement in response to the allocation request,

a list of available networks for providing the requested extra spectrum,

an indication of a spectrum window for providing the requested extra spectrum.

16. A method performed by a cloud spectrum broker, the method comprising:

listening for a spectrum allocation request from a user equipment, the spectrum allocation request for requesting extra spectrum, the spectrum allocation request according to a predetermined protocol;

requesting extra spectrum from a global broker according to the predetermined protocol;

receiving a response from the global broker, the response from the global broker according to the predetermined protocol; and

sending a response to the user equipment based on the response from the global broker, the response to the user equipment according to the predetermined protocol.

17. The method of clause 16, wherein the spectrum allocation request from the user equipment includes at least one of:

an indication of a mobility model for the requested extra spectrum,

an indication of a radio interface for the requested extra spectrum,

authorization information associated with the spectrum allocation request,

a put price.

18. The method of clause 16 or 17, wherein the response to the user equipment includes at least one of:

an acknowledgement in response to the spectrum allocation request,

a list of available networks for providing the requested extra spectrum,

an indication of a spectrum window for providing the requested extra spectrum.

19. A user equipment comprising:

means to determine that extra spectrum should be requested;

means to determine information to be sent in an allocation request, the allocation request for requesting allocation of extra spectrum; and

means to send an allocation request for requesting extra spectrum to a cloud spectrum broker, the allocation request being sent according to a predetermined protocol.

20. A spectrum broker comprising:

means to listen for an allocation request from a user equipment, the allocation request for requesting allocation of extra spectrum, the allocation request according to a predetermined protocol;

means to request extra spectrum from a global broker according to the predetermined protocol;

means to receive a response from the global broker, the response from the global broker according to the predetermined protocol; and

means to send a response to the user equipment based on the response from the global broker, the response to the user equipment according to the predetermined protocol.

21. A computer program that when executed by a computer causes the computer system to perform the method of any one of clauses 8 to 10 or 16 to 18 to perform as the device of any one of clauses 1 to 7, 11 to 15, 19 or 20.

22. A non-transitory storage machine-readable storage medium having stored thereon instructions that, when executed by a computer, cause the computer to perform the method of any one of clauses 8 to 10 or 16 to 18, or operate as the apparatus of any one of clauses 1 to 7, 11 to 15, 19 or 20.

23. A User Equipment, UE, substantially as described herein with reference to the drawings.

24. A cloud spectrum broker substantially as described herein with reference to the drawings.

25. A method substantially as described herein with reference to the drawings.

1. A device for use in a mobile communication user equipment, UE, the device comprising processing circuitry to:
prepare a spectrum allocation request for requesting extra spectrum according to a predetermined protocol;
send the spectrum allocation request to a cloud spectrum broker; and
receive a response to the spectrum allocation from the cloud spectrum broker.

2. The device of claim 1, wherein the processing circuitry is to send further information to the cloud spectrum broker, the further information including at least one of:
an indication of a mobility model for the requested extra spectrum,
an indication of a radio interface for the requested extra spectrum,
authorization information associated with the spectrum allocation request,
a put price.

3. The device of claim 2, wherein the processing circuitry is to prepare the further information according to the predetermined protocol before sending the further information to the cloud spectrum broker.

4. The device of claim 1, wherein the processing circuitry is further to receive an acknowledgement from the cloud spectrum broker in response to the spectrum allocation request.

5. The device of claim 1, wherein the processing circuitry is further to receive, from the cloud spectrum broker, a list of available networks for providing the requested extra spectrum.

6. The device of claim 1, wherein the processing circuitry is further to receive, from the cloud spectrum broker, an indication of a spectrum window for providing the requested extra spectrum.

7. A user equipment comprising:
the device of claim 1; and
one or more of: a screen, a speaker, a touchscreen, a keyboard, an antenna array including a plurality of antennas, a graphics processor, an application processor.

8. A method of requesting extra spectrum, the method comprising:
determining that extra spectrum should be requested;
determining information to be sent in an allocation request, the allocation request for requesting allocation extra spectrum; and
sending the allocation request to a cloud spectrum broker, the allocation request being sent according to a predetermined protocol.

9. The method of claim 8, wherein the method further comprises sending to the cloud spectrum broker at least one of:
an indication of a mobility model for the requested extra spectrum,
an indication of a radio interface for the requested extra spectrum,
authorization information associated with the allocation request,
a put price.

10. The method of claim 8, wherein the processing circuitry is further to receive from the cloud spectrum broker at least one of:
an acknowledgement in response to the allocation request,
a list of available networks for providing the requested extra spectrum,
an indication of a spectrum window for providing the requested extra spectrum.

11. A device for use in a cloud spectrum broker, the device comprising processing circuitry to:
receive from a user equipment an allocation request, the allocation request for requesting extra spectrum, the allocation request according to a predetermined protocol;
determine a response to the allocation request; and
send the response to the user equipment.

12. The device of claim 11, wherein the response to the user equipment is according to the predetermined protocol.

13. The device of claim 11, wherein the allocation request includes at least one of:
an indication of a mobility model for the requested extra spectrum,
an indication of a radio interface for the requested extra spectrum,
authorization information associated with the allocation request,
a put price.

14. The device of claim 11, wherein the processing circuitry is to
send a request for spectrum to a global broker;
receive a response to request for spectrum from the global broker; and
determine the response to the allocation request based on the response to the request for spectrum.

15. The device of claim 11, wherein the response to the user equipment includes at least one of:
an acknowledgement in response to the allocation request,
a list of available networks for providing the requested extra spectrum,
an indication of a spectrum window for providing the requested extra spectrum.

16. A non-transitory storage machine-readable storage medium having stored thereon instructions that, when executed by a computer, cause the computer to perform the method of claim 8.
